(19) United States
(12) Patent Application Publication
(10) Pub. No.: US 2022/0018487 A1
(43) Pub. Date: Jan. 20, 2022

(54) REFRIGERATION APPLIANCE HAVING CABLE BUSHING

(71) Applicant: BSH HAUSGERAETE GMBH, MUENCHEN (DE)

(72) Inventors: MING ZHANG, ULM (DE); ANDREAS VOGL, HAUNSHEIM (DE); BERTHOLD PFLOMM, ULM (DE); KLAUS FLINNER, ZOESCHINGEN (DE)

(21) Appl. No.: 17/294,473

(22) PCT Filed: Oct. 23, 2019
(86) PCT No.: PCT/EP2019/078822

§ 371 Date: May 17, 2021

(30) Foreign Application Priority Data
Nov. 19, 2018 (DE) 10 2018 219 746.6

(51) Int. Cl. F16L 59/12; F25D 23/06; F16L 5/10

(52) U.S. Cl. CPC F16L 59/121; F16L 5/10; F25D 23/068

(57) ABSTRACT

A refrigeration appliance has a refrigeration chamber, a thermal insulation layer, and a wall extending between the refrigeration chamber and the thermal insulation layer. A pipe support is integrally formed with the wall and surrounds an opening in the wall. A line extends through the pipe support. An elastic sleeve has a first end section, fixed on a free end of the pipe support, and a second end section, abutting the line.

The present invention relates to a refrigeration appliance, in particular a household refrigeration appliance, in which a refrigeration chamber is separated from a surrounding thermal insulation layer by means of a wall, typically an inner container wall, and a line runs through an opening in the wall. The thermal insulation layer is typically produced by a synthetic resin being injected into a cavity on the side of the wall facing away from the refrigeration chamber and being allowed to expand therein. If the opening, through which the line runs, is not adequately sealed in this process, the expanding foam can penetrate the refrigeration chamber through this opening. If this occurs, the affected appliance must usually be discarded since an elimination of all traces of the penetrated foam is not possible. Moreover, with an inadequate sealing of the opening, there is the risk of moisture from the refrigeration chamber entering the thermal insulation layer and hampering its insulation effect.

A known technique for sealing such an opening involves wrapping adhesive tape around a pipe support molded around the opening on the wall and wrapping adhesive tape around the line. This technique requires a high degree of manual labor and the impermeability against moisture is difficult to ensure. Instead of the adhesive tape, a butyl pad can also be used; however, a further time-consuming work step of vulcanization is required at the installation location.

The object of the invention is to create a technique which enables a reliable sealing of the opening with a minimal expenditure of time.

The object is achieved according to the invention by, in the case of a refrigeration appliance having a refrigeration chamber, a thermal insulation layer and a wall extending between the refrigeration chamber and the thermal insulation layer, a pipe support which is integral with the wall and surrounds an opening in the wall and a line extending through the pipe support, an elastic sleeve that has a first end section, fixed on a free end of the pipe support, and a second end section, abutting the line.

In order to prevent the sleeve from detaching from the wall during the assembly, particularly if the refrigerant pipe has to be moved through the sleeve which is already mounted on the wall, the sleeve can be fastened to the pipe support in a form-fit manner and/or by means of adhesion.

In particular, if the sleeve is only subsequently slid onto the already mounted refrigerant pipe and the pipe support, a friction fit between the sleeve and the pipe support may be sufficient.

In order to ensure that the sleeve is fixedly connected to the wall before the foaming process, the first end section can be elastically expanded through the pipe support.

The form-fit anchoring can be provided by a bulge in the pipe support or the first end section which protrudes outward or inward in the radial direction of the opening, said bulge being received by a notch in the respective other component.

According to a preferred embodiment, it is sufficient if this form fit along the line is only effective in one direction. For this purpose, the pipe support can extend on a side of the wall facing away from the thermal insulation layer, and the first end section can have a notch, which receives at least one end of the pipe support which faces away from the wall. It is then possible firstly to slide the sleeve into the opening to put over the free end of the pipe support from the side of the refrigeration chamber, and then to slide the line through the opening from the same side. Here tension exerted onto the sleeve in any case reinforces the engagement of the pipe support into the notch, but cannot result in leakage.

To ensure that the pipe support inside the refrigeration chamber does not impede the attachment of other components, it can be molded to the base of a protuberance of the wall which protrudes into the thermal insulation layer.

To ensure a tight attachment of the sleeve to the line, the second end section of the sleeve should be expanded elastically by the line inserted therein.

The second end section can be molded as a pipe section with a diameter which is constant in the longitudinal direction of the sleeve; in this way an effectively sealing contact with the line is ensured over the entire length of the second end section.

In order to facilitate the introduction of the refrigerant pipe into the sleeve, it may be useful if the entire inner surface of the pipe section does not abut the pipeline. Therefore, the second end section can advantageously have at least one projection which protrudes from an inner surface of the pipe section. The projection preferably extends around the entire periphery of the inner surface.

In order to improve the flexibility of the sleeve, it may have a wavy intermediate section, in which regions with a large cross-section and regions with a small cross-section alternate with one another.

The regions with a small cross-section preferably have an inner diameter which is greater than the outer diameter of the line, so that upon insertion into the sleeve the line can pass unhindered through these regions.

The regions with alternately large and small diameters are relatively complicated to mold. In order to simplify manufacture of the sleeve, regions with cross-sections which decrease gradually toward the second end section can be formed instead in the intermediate section.

These regions with different cross-sections can be connected by walls aligned radially with respect to a longitudinal axis of the sleeve.

A greater flexibility of the sleeve can be achieved if the regions with different cross-sections overlap with one another in pairs in the axial direction, and the walls which connect adjacent sections are widened in each case in the manner of a truncated cone and toward the second end section.

If the sleeve is integrated in the refrigeration appliance, a longitudinal axis of the first end section and a longitudinal axis of the second section can have alignments which deviate from one another by at least 45°.

The line can be in particular a refrigerant line, for instance for supplying an evaporator arranged in the refrigeration chamber.

After assembly, the sleeve is preferably embedded in the thermal insulation layer of the refrigeration appliance.

Further features and advantages of the invention will emerge from the description of exemplary embodiments provided below, with reference to the attached drawings, in which:

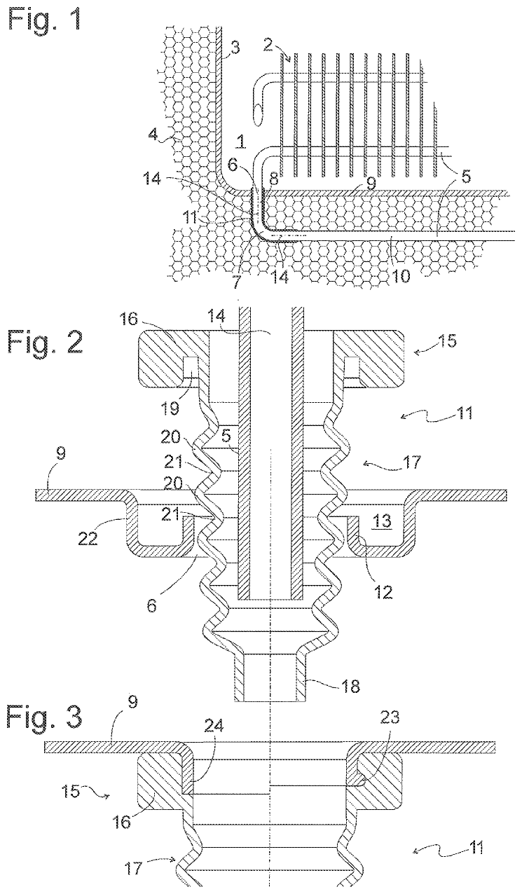

FIG. 1 shows a section through a detail of a refrigeration appliance with a refrigerant line bushing;

FIG. 2 shows an opening of an inner container wall of an inventive refrigeration appliance with a sleeve positioned thereon;

FIG. 3 shows an opening of an inner container wall with a sleeve attached to a pipe support surrounding the opening, according to a second embodiment of the invention;

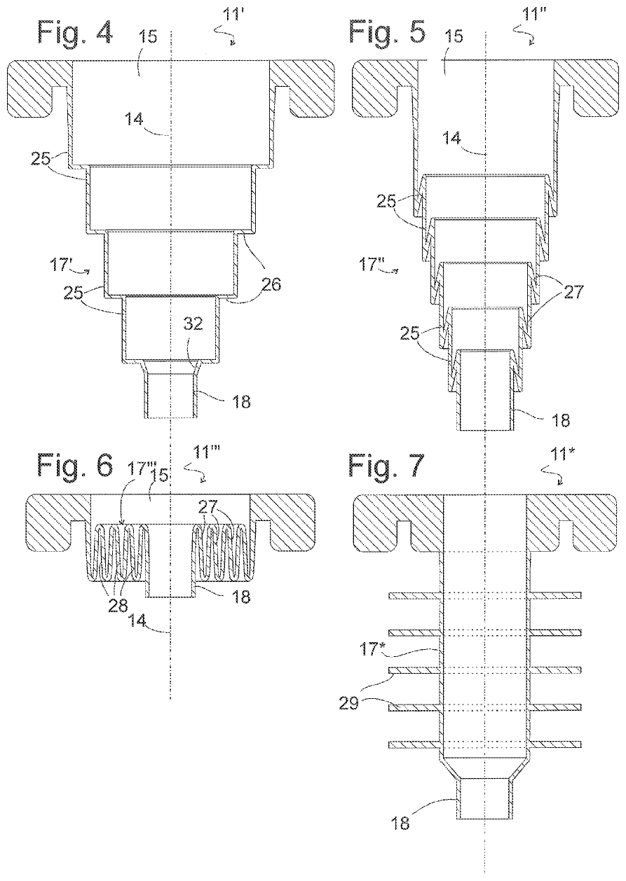

FIG. 4 shows an axial section through a sleeve according to a third embodiment;

FIG. 5 shows an axial section through a sleeve according to a fourth embodiment;

FIG. 6 shows an axial section through a sleeve according to a fifth embodiment;

FIG. 7 shows an axial section through a sleeve according to a sixth embodiment;

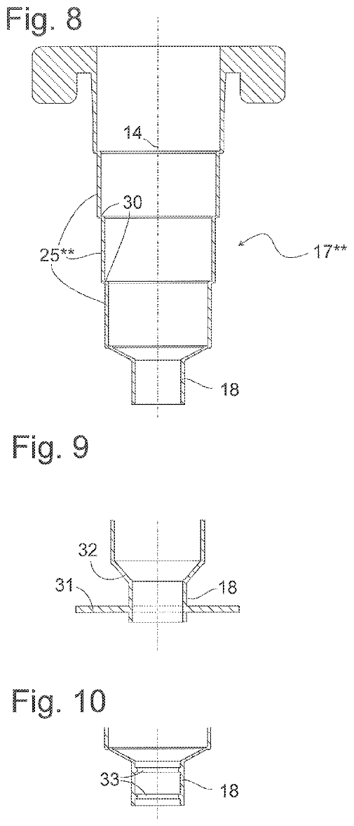

FIG. 8 shows an axial section through a sleeve according to a seventh embodiment;

FIG. 9 shows an axial section through a sleeve according to an eighth embodiment of the invention; and

FIG. 10 shows a development which can be combined with the embodiments described.

FIG. 1 shows a typical example application of the invention. The sectional plane in FIG. 4 runs horizontally through a part of a refrigeration chamber 1 of a household refrigeration appliance, an evaporator 2 arranged therein, here a fin evaporator, an inner container 3 delimiting the refrigeration chamber 1 and a thermal insulation layer 4 made from expanded plastic and adjoining the inner container 3 on the outside. A refrigerant line 5 for supplying the evaporator 2 runs with part of its length in the thermal insulation layer 4 and with another part in the refrigeration chamber 1. Between these parts, it passes through an opening 6 of the inner container 3. This opening 6 must be carefully sealed during assembly of the appliance in order to ensure that while the thermal insulation layer is being foamed, no insulation foam passes through the opening 6 into the refrigeration chamber 1 and during operation of the refrigeration appliance no moisture from the refrigeration chamber can penetrate the thermal insulation layer 4.

The sealing of the opening 6 then raises problems in particular if the refrigerant line 5 in the vicinity of the opening 6 in the thermal insulation layer 4 is molded to form an arc 7. Such an arc 7, which extends over an angle of approx. 90°, is frequently required to form a transition between a line section 8, which intersects a wall 9, typically a rear wall, of the inner container 3 at a right angle, and a line section 10, which, in the thermal insulation layer 4, runs parallel to, and as far as possible at a minimal distance from, the wall 9. A sealing sleeve 11, which is arranged between the edges of the opening 6 and the refrigerant line 5 intersecting the opening, in order to keep the insulation foam from the layer 4 away from the refrigeration chamber 1, is shown schematically; longitudinal axes 14 of its two end sections, which coincide in the relaxed state of the sleeve 11, are forced through the refrigerant line 5 in a configuration which is twisted by approx. 90° with respect to one another.

FIG. 2 shows a piece of the wall 9 with the opening 6 formed therein and the sleeve 11 according to a first embodiment of the invention, in a state in which it is partially inserted into the opening 6.

Here the opening 6 is surrounded by a pipe support 12 which protrudes in the direction of the refrigeration chamber 1. The pipe support 12 can be obtained, for instance, by the wall 9 being heated to a plastically deformable state and perforated by a pin in order to form the opening 6.

The pipe support 12 could protrude into the refrigeration chamber 1 from the plane of the wall 9; in the case shown here, it is molded to the base of a depression 13 of the wall 9, so that it does not project beyond the surrounding wall 9 into the refrigeration chamber 1, but instead a channel extends around the pipe support 12.

The sleeve 11 shown in sections along its longitudinal axis 14 in FIG. 2 is an integral mold manufactured from rubber elastic material preferably by means of die casting. A first end section 15 of the sleeve 11 comprises a flange 16 which extends in a ring around the longitudinal axis 14, on the side of which flange facing a central section 17 and on a second end section 18 of the sleeve 11 a peripheral notch 19 is cut out. The flange 16 and the notch 19 are dimensioned so that if the flange 16 is pressed into the depression 13, the pipe support 12 engages in the notch 18. The shapes of the depression 13 and the flange 16 are preferably adjusted to one another so that in its fixedly mounted position the flange 16 fills the depression 13 exactly and its side facing away from the second end section 18 is flush with the surface of the wall 9. In particular, outer walls 22 of the depression 13, as shown in FIG. 1, can be parallel to the longitudinal axis 14 of the pipe support 12 or undercut in order to enable the flange 16 to be fixed in the depression 13 also by friction fit or form fit between a peripheral surface of the flange 16 and the outer walls 22.

The central section 17 of the sleeve 11 has the form of a flexible hose, in which regions with a large cross-section 20 and regions with a small cross-section 21 alternate with one another. The diameter of the regions 20 and the diameter of the regions 21 in each case reduce gradually toward the second end section 18. This measure facilitates the demolding of the sleeve 11 from an injection molding tool, particularly the removal of a pin used to mold the interior of the sleeve 11.

The second end section 18 has the shape of a pipe piece with a constant diameter. This diameter is marginally smaller than the refrigerant line 5 to be inserted into the sleeve 11, so that if the refrigerant line 5 runs through the sleeve 11, the second end section 18 tightly abuts it.

When the refrigerant line 5 is inserted from the refrigeration chamber 1 side, the sleeve 11 is held on the pipe support 12 in a form-fit manner; a tensile force, which acts on the sleeve 11 when the refrigerant line 5 is pushed forward, holds the flange 16 against the base of the channel 13.

The friction between the refrigerant line 5 and the second end section 18 ensures that the sleeve 11 is under tensile stress after the refrigerant line has been inserted, said tensile stress pressing the flange 16 against the base of the channel 13, and thus contributing to the flange 16 remaining immobile in the channel 13, even if it is exposed to an overpressure of the expanding insulation foam during the foaming process.

The central section 17 is easy to stretch as a result of the wave shape and can therefore also adjust without any problem to the shape of the arc 7, without stress forces that occur in the sleeve 11 driving the flange 16 out of the channel 13 again. The friction between the flange 16 and the pipe support 12 and an outer wall 22 of the channel 13 is sufficient to fix the flange 16 in this position in the channel 13 as well and to keep the opening 6 foam-tight.

FIG. 3 shows a sleeve 11, mounted on a pipe support 24 of the wall 9, according to a second embodiment of the invention. Contrary to the pipe support 12 in FIG. 1, the pipe support 24 protrudes from the side of the wall 9 facing away from the refrigeration chamber. Here the first end section 15 of the sleeve also comprises a flange 16, which is put over the pipe support 24. The remaining sections 17, 18 are identical to those shown in FIG. 2 and are therefore not shown again in full. In order to ensure it remains in place if the refrigerant line is pushed through the opening 6 and the sleeve 11, the flange 16 is glued to the exterior of the pipe support 24 and/or the foam-side surface of the wall 9. As is the case in FIG. 2, the wavy profile of the central section 17 supports a bending of the sleeve 11 if the arc 7 of the refrigerant pipe 5 engages therein.

In order to further reduce the tendency of the flange 16 to detach from the pipe support 24 when the sleeve 11 is under tensile or bending stress, a form-fit can be provided between the flange 16 and the pipe support 24. To this end, as shown in the right half of FIG. 3, a radially projecting bulge 23 is molded on the pipe support 24, e.g. by the pipe support 24 recently molded, by penetrating the wall 9, being compressed again while still soft, and a notch receiving the bulge 22 being cut out on the flange 16.

In the case shown in FIG. 2, a corresponding pairing of a notch and a fin engaging therein can also be provided on the pipe support 12 and/or the outer wall 22 and the surface of the flange 16 which faces this in each case, in order to improve the ability of the flange 16 to withstand an overpressure of the insulation foam without moving out of the channel 13.

While the sleeve in FIG. 2 either has to be slid firstly onto the refrigerant line 5 or the pipe support 12 before the refrigerant line 5 or an evaporator connected thereto can be mounted on the inner container 3, the sleeve 11 in FIG. 3 can also be slid onto the refrigerant line 5 after the latter has been mounted on the inner container 3, until its first end section 15 reaches the pipe support 24. In this case, a simple friction fit between the first end section 15 and the pipe support 24 may be sufficient to fix the end section 15 securely on the pipe support 24 until foaming.

FIGS. 4 to 9 show sleeves with differently modified central sections. Although the first end sections 15 of these sleeves are all of the type shown in FIG. 2, it is apparent that they can also be combined with a first end section of the type shown in FIG. 3.

In the case of the sleeve 11′ in FIG. 4, the central section 17′ is composed of a sequence of cylindrical regions 25, the diameters of which reduce gradually from the first end section 15 to the second 18, and which are connected with one another by ring-shaped walls 26 which are at right angles to the longitudinal axis 14. This sleeve 11′ can also be placed under tensile stress by the insertion of the refrigerant pipe 5; its expandability essentially takes the form of the ring-shaped walls 26 assuming a truncated cone shape by effecting a tensile stress, and with the same length and wall thickness it is therefore generally smaller than that of the sleeve 11 with the wavy central section 17 according to FIG. 2. The advantage of the sleeve 11′ consists in its interior being free of undercuts and it therefore being easier to manufacture than the sleeve 11.

In order to facilitate the introduction of the refrigerant pipe 5 into the second end section 18, a truncated cone-shaped transition 32 can be formed between this and the central section 17′.

The sleeve 11″ in FIG. 5 has a central section 17″, in which cylindrical regions 25 with a diameter which reduces gradually toward the second end section 18 alternate with truncated cone-shaped regions 27. The small base area of the truncated cone-shaped regions 27 faces the first end section 15 in each case, so that the cylindrical regions 25 are meshed into one another telescopically along the axis 14. Under tensile load the truncated cone-shaped regions 27 fold down so that the sleeve 11″ can be extended very significantly in its longitudinal direction, but generally after a region 27 folds down it can no longer revert elastically to the configuration in FIG. 5.

The sleeve 11″ is also easy and cheap to produce since it is free of undercuts; moreover, it can adjust well to an arc 7 in the refrigerant line 5 by at least one of the truncated cone-shaped regions only folding down on one part of its periphery.

In the central section 17′″ of the sleeve 11′″ in FIG. 6, cylindrical and truncated cone-shaped regions or regions 28 which converge toward and regions 27 which diverge away from the second end section 18 likewise alternate. Here the diverging regions 27 can also fold down under tensile stress into a configuration which converges toward the second end section 18. The expansion of the regions 27, 28 in the direction of the axis 14 is essentially identical, which provides the sleeve 11′″ with a particularly compact design.

The sleeve 11* in FIG. 7 has a central section 17* of an essentially cylindrical design or one which tapers slightly conically with respect to the second end section 18, from which fins 29 extending in a circle at a distance from one another project along the axis 14. The wall thickness of the central section 17* is low in order to facilitate, if the central section 17* has to curve to fit the arc 7 of the refrigerant line 5, yielding by means of elastic expansion of the central section 17* on the exterior of the arc 7 and folding down into its interior. The fins 29 are provided to prevent the central section 17* from collapsing despite its low wall thickness during foaming, and from being pressed against the refrigerant line 5 running through it. To ensure this can be achieved, the wall thickness of the fins 29 can be selected to be larger than that of the central section 17*.

FIG. 8 shows an embodiment of the sleeve 11** in which the central section 17** is subdivided into cylindrical regions 25** with a diameter which reduces gradually toward the second end section 18. The difference in radius between adjacent regions 25** corresponds approximately to their wall thickness; steps 30 between them in each case form weak points which tend to buckle under pressure in the direction of the axis 14. The central section 17** thus bends in the manner of a fan on the interior of the arc 7 when inserted into the sleeve 11**, while it can be expanded on the exterior by means of tensile stress.

All embodiments of the sleeve described above can be provided on its second end section 18 with a reinforcing peripheral flange 31, as shown in FIG. 9. The flange engages in the hardened foam of the thermal insulation layer 4, which ensures that stresses present in the sleeve while the appliance is being used cannot cause the sleeve to become detached from the foam, slip, and produce gaps that form cold bridges or could facilitate the penetration of moisture into the foam.

When the second end section 18 is expanded over its entire length by the inserted refrigerant line 5, the resulting friction can significantly hamper the insertion of the refrigerant line 5, especially in the case in FIG. 9, wherein the peripheral flange 31 hampers an expansion of the end section 18. In order to limit the friction which occurs upon insertion, the second end section 18, as shown in FIG. 10, can be provided with at least one projection 33, which projects from an interior of the end section, touching the refrigerant line 5 and preventing surrounding regions of the interior from coming into contact with the refrigerant line 5. The projection 33 preferably extends in the manner of a continuous sealing lip around the entire periphery of the inner surface or the refrigerant line 5. A number of projections 33 can be arranged one above the other in the axial direction.

### REFERENCE CHARACTERS

| | |
|---|---|
| 1 | refrigeration chamber |
| 2 | evaporator |
| 3 | inner container |
| 4 | thermal insulation layer |
| 5 | refrigerant line |
| 6 | opening |
| 7 | arc |
| 8 | line section |
| 9 | wall |
| 10 | line section |
| 11 | sleeve |
| 12 | pipe support |
| 13 | channel |
| 14 | longitudinal axis |
| 15 | first end section |
| 16 | flange |
| 17 | central section |
| 18 | second end section |
| 19 | notch |
| 20 | region with a large cross-section |
| 21 | region with a small cross-section |
| 22 | outer wall |
| 23 | bulge |
| 24 | pipe support |
| 25 | cylindrical region |
| 26 | ring-shaped wall |
| 27 | truncated cone-shaped region |
| 28 | truncated cone-shaped region |
| 29 | fin |
| 30 | step |
| 31 | flange |
| 32 | transition |
| 33 | projection |

1-16. (canceled)

17. A refrigeration appliance, comprising:
a refrigeration chamber, a thermal insulation layer, and a wall extending between said refrigeration chamber and said thermal insulation layer;
a pipe support integrally formed with said wall and surrounding an opening formed in said wall;
a line extending through said pipe support; and
an elastic sleeve having a first end section affixed to a free end of said pipe support and a second end section abutting said line.

18. The refrigeration appliance according to claim 17, wherein said sleeve is fastened to said pipe support with at least one of a form-fit or by glue adhesion.

19. The refrigeration appliance according to claim 17, wherein the first end section of said elastic sleeve is elastically expanded by said pipe support.

20. The refrigeration appliance according to claim 17, wherein one of said pipe support and said first end section has a bulge protruding in a radial direction and another of said pipe support and said first end section is formed with a notch receiving said bulge.

21. The refrigeration appliance according to claim 17, wherein said pipe support extends on a side of said wall that faces away from said thermal insulation layer and the first end section is formed with a notch configured to receive at least one end of said pipe support that faces away from said wall.

22. The refrigeration appliance according to claim 21, wherein said pipe support is formed on a base of a depression of said wall that projects into said thermal insulation layer.

23. The refrigeration appliance according to claim 17, wherein the second end section of said sleeve is elastically expanded by said line.

24. The refrigeration appliance according to claim 17, wherein the second end section of said sleeve has a diameter which is constant in a longitudinal direction of the sleeve.

25. The refrigeration appliance according to claim 17, wherein the second end section comprises a pipe section and at least one projection that projects from an inner surface of said pipe section.

26. The refrigeration appliance according to claim 17, wherein said sleeve is formed with a wavy intermediate section, said wavy intermediate section having regions with a relatively large cross-section alternating with regions with a relatively small cross-section.

27. The refrigeration appliance according to claim 26, wherein the regions with the relatively small cross-section have an inner diameter which is larger than an outer diameter of said line.

28. The refrigeration appliance according to claim 17, wherein said sleeve has an intermediate section with regions formed with cross-sections that decrease gradually toward the second end section of said sleeve.

29. The refrigeration appliance according to claim 28, wherein the regions of decreasing cross-sections are connected by walls oriented radially with respect to a longitudinal axis of said sleeve.

30. The refrigeration appliance according to claim 28, wherein the regions of decreasing cross-sections overlap axially in pairs and are connected by truncated cone-shaped walls which widen out toward the second end section of said sleeve.

31. The refrigeration appliance according to claim 17, wherein a longitudinal axis of the first end section and a longitudinal axis of the second end section have alignments which deviate from one another by at least 45°.

32. The refrigeration appliance according to claim 17, wherein the line is a refrigerant line.

33. The refrigeration appliance according to claim 17, configured as a household refrigeration appliance,
